(19) United States
(12) Patent Application Publication
(10) Pub. No.: US 2012/0239377 A1
(43) Pub. Date: Sep. 20, 2012

(54) Interpretor phone service

(76) Inventors: Charles C. Scott, Newport News, VA (US); Theseus C. Scott, Stone Mountain, GA (US); Chartrice Lachelle Scott, Carrollton, GA (US)

(21) Appl. No.: 12/654,760

(22) Filed: Dec. 31, 2009

Related U.S. Application Data
(60) Provisional application No. 61/193,860, filed on Dec. 31, 2008.

(51) Int. Cl. G06F 17/28

(52) U.S. Cl. 704/2

(57) ABSTRACT

These drawings are submitted only as a standard for development. There are numerous ways a developer could complete this phase.

FIG. 1. Depicts a blow up of the web screen to open and enter interpreter program.

FIG. 2. Depicts the different vocabularies in the system to choose from. Illustrated by flags from different countries.

FIG. 3. Depicts the chosen language for link up. In this particular example it is the Spanish flag. This may contain a directional configuration for dialects.

FIG. 4. Depicts the language that have been linked to use; the person speaking presses the flag or cursor to indicate which language is being spoken. Streaming is done automatically upon release of cursor.

FIG. 5. Is a schematic diagram of the matrix pertaining to the flow of the system.

FIG. 6. This is a schematic of the binaries.

### BACKGROUND

1. Field

This innovation relates to communication between people of different ethnic backgrounds. It interprets what you are saying into the language of the person you are speaking to.

2. Prior Art

The only relative inventions known are from one unit to a secondary unit that limits itself to writing messages. In this application there are no previous intentions of this nature known. This is a single unit in a bow that speaks directly to the parties that are present.

In the past, people traveling to foreign countries had to hunt for someone who could understand what they were trying to say and who they themselves could understand, on the streets of whatever country they might find themselves in. The alternative was to hire an interpreter; not anymore! This is an interpreter in your pocket. Today, even in this country, a person might find themselves in areas or situations where an interpreter is needed.

### SUMMARY

This is an interpreter that will always be with you and ready to serve your communication needs. Even though there is a number of ways development may be done, I am submitting this as a standard development.

### BRIEF SUMMARY OF INVENTION

This invention is for a program/application, on a cellular phone, that will allow two people to of different languages to speak directly with one another. The matrix will allow the language that is spoken by the first party to be translated into the language of the second party and vice versa. The person with the device selects his language as the default. And by pressing the corresponding icon, he can access this application and select the language of the second party he wants translated into his default language. It will also translate his language (the default) back to the second party in the selected language.

### BRIEF DESCRIPTION OF DRAWINGS

These drawings are submitted only as a standard for development. There are numerous ways a developer could complete this phase.

FIG. 1: Shows a blow up of the web screen to open and enter interpreter program.

FIG. 2: Shows the different languages in the system to choose from; illustrated by flags from different countries.

FIG. 3: Is the chosen language for link up. In this example it is the Spanish flag. This may contain a directional configuration for dialects.

FIG. 4: Shows the languages that have been linked. To use, the person speaking presses the flag or cursor to indicate which language is being spoken. Streaming is done automatically upon release of cursor.

FIG. 5: Is a schematic diagram of the matrix pertaining to the flow of the system.

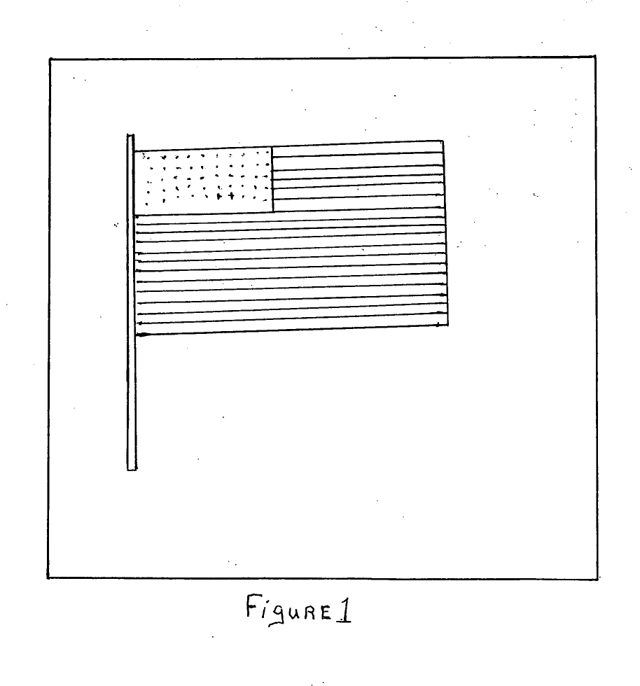

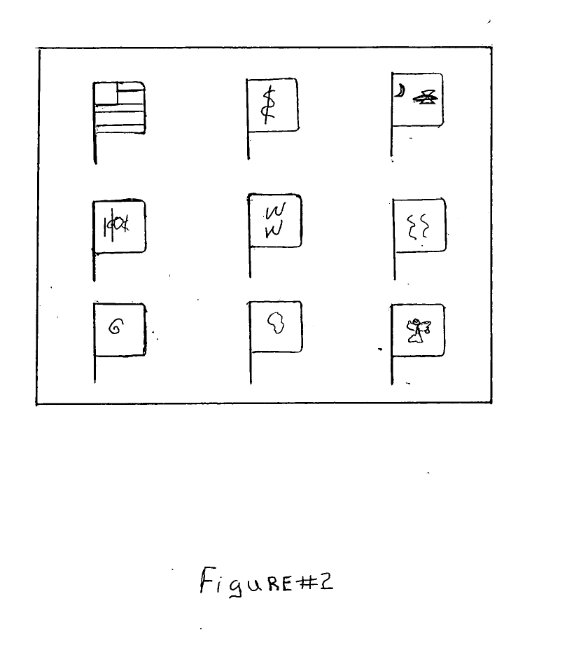

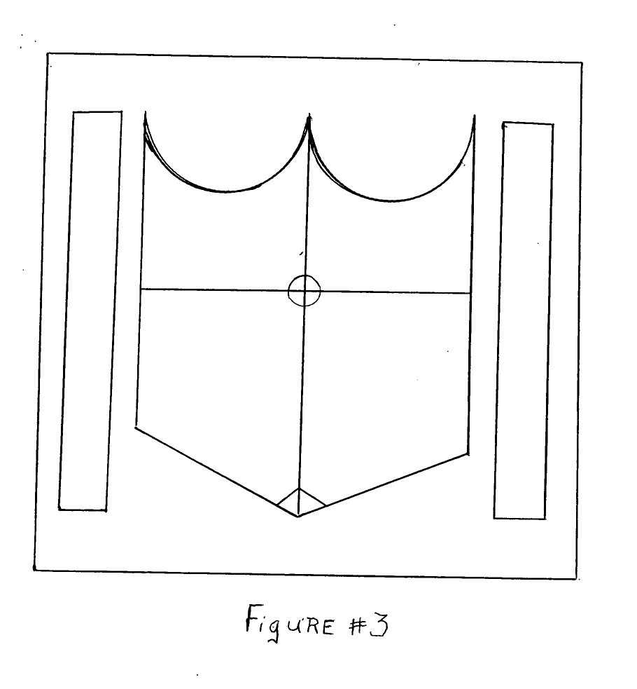

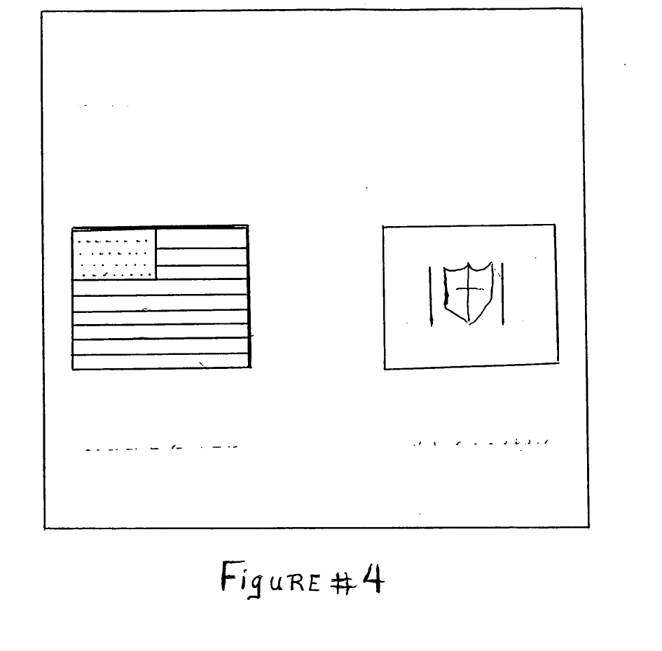

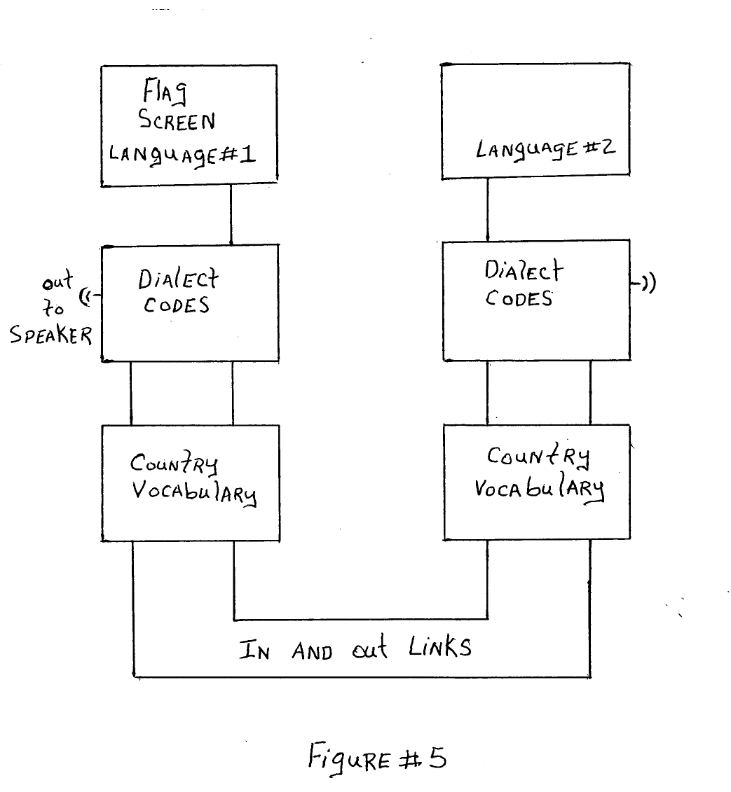

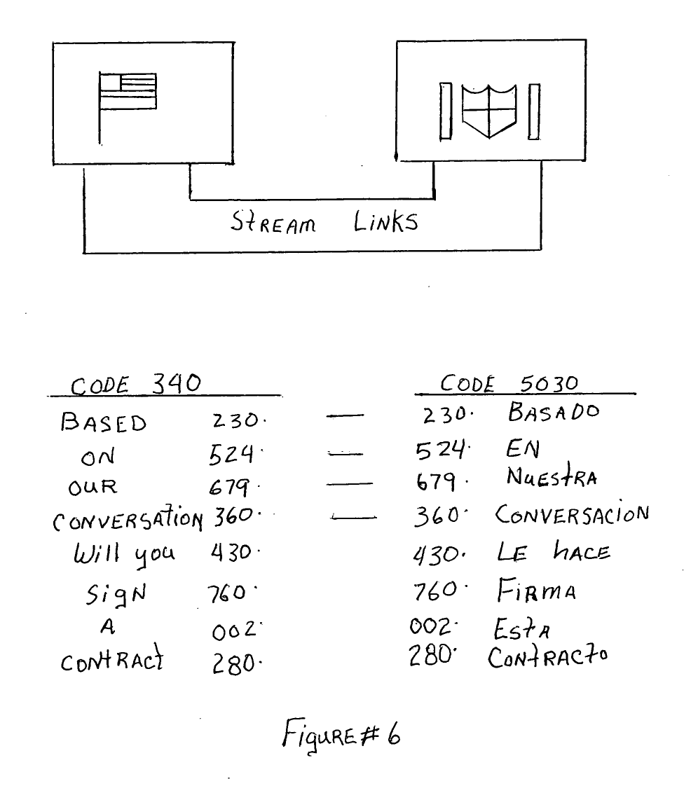

1. The innovation will allow two people of different language origins to instantly speak of communicate directly with each other. It will largely eliminate the need to wait for or hire and interpreter.
Through proper construction and installation of its matrix it will add clarity and integrity in all their communication. This is a much needed aspect of business today, as it would increase confidence that your communication is being properly relayed and will induce better understanding
This device will enhance the global trade and economy astronomically. It will give many more people the ability and confidence to travel to other countries and seek to do business.
People who already travel to foreign countries will no longer have to look for someone who speaks their language. Their interpreter will always be with them; right in their pocket/briefcase. With the push of a button they will be able to give or receive need information. The potential of bringing the world together with this innovation is unbounded.
